(19) United States
(12) Patent Application Publication
(10) Pub. No.: US 2010/0121653 A1
(43) Pub. Date: May 13, 2010

(54) METHOD FOR TRACKING AND SORTING MEDICAL TEST INFORMATION

(76) Inventor: Keat Jin Lee, Guilford, CT (US)

Correspondence Address: MICHAUD-Kinney Group LLP, 306 INDUSTRIAL PARK ROAD, SUITE 206, MIDDLETOWN, CT, 06457, US

(21) Appl. No.: 12/267,758

(22) Filed: Nov. 10, 2008

(51) Int. Cl. G06Q 50/00

(52) U.S. Cl. 705/3

(57) ABSTRACT

In a method for tracking medical test information a content database is established and is cooperable with software, the content database being populable with identifying information relevant to particular patients and care providers. Information relevant to tests performed or to be performed on one or more of the patients is received and associated with the patient. The information stored in the database and retrievable therefrom, includes; the type of test, who ordered a particular test, when it is ordered, when was the scheduling done for the test, who scheduled it, when was the test scheduled to be performed, when was it performed, what was the expected date of the test results, when did the results actually become available, when were the test results read, when were the test results conveyed to the patient, and when did the final disposition occur. The software being operable to sort at least a portion of said information upon request by a user.

### Field of the Invention

The present invention generally relates to the maintenance of a patient's medical records and is more particularly directed to tracking and sorting information related to medical tests.

### BACKGROUND

Maintaining accurate and complete test records for patients, prescribing physicians and institutions has always been important to proper medical care. Having access to, and the ability to track these test records is also important. Historically, hard copies of a particular patient's medical records were maintained. Gaining access to such records, particularly by a care provider other than one that ordered or administered the test often took several days, or a patient would have to retrieve his/her own records and bring them to the other care provider. With the advent of e-mail and the ability to send electronic versions of medical records, this process can be more expeditious, however, a request for the records must be made and someone must forward the test results to the requesting entity, thereby introducing the possibility for human error. Because, test results can be resident in different locations, the same test for the same patient can be ordered by different care providers who were not aware that such a test had already been done.

Several steps generally need to take place in order for a care provider to have a test accomplished on a patient and the results of the test interpreted by the care provider. For example, the test must be ordered, someone must schedule the test, the test must be conducted, the results forwarded to the care provider, and the care provider must interpret the results. Currently, it is difficult for medical practices, insurers or other institutions to monitor all of these activities to ensure that they are accomplished in a timely manner. Moreover, it is difficult for a care provider to readily ascertain, the number of tests, whether the same or different, that need to be accomplished in a given time frame or that have been done for a particular patient.

### SUMMARY

The present invention is directed in one aspect to a method for tracking the results of medical tests. A computer implemented method is employed whereby a database is populated with information relevant to a particular test ordered. The relevant information may include, but is not limited to the type of test, who ordered a particular test, when it is ordered, when was the scheduling done for the test, who scheduled it, when was the test scheduled to be performed, when was it performed, what was the expected date of the test results, when did the results actually become available, when were the test results read, when were the test results conveyed to the patient, and when did the final disposition occur. The steps to be taken upon interpretation of the test results can also be stored in the database.

The database can be resident on a server accessible by one or more users. For example, the database can be resident on a server used in a doctor's office where one or more persons in the office can access it. The server can also be resident in a facility such as, for example, a hospital where multiple doctors across several different disciplines can access the database. Software cooperative with the database can be employed to provide a user with an interface whereby tests can be ordered and tracked. The tests information is stored in an electronic filing cabinet that. Accordingly, the medical personnel involved in all aspects of ordering, conducting, and interpreting the tests can enter the relevant information, via the user interface, into the database. The database also includes identifying information unique to the patient for which a test is ordered and any test information for a particular patient is associated with the identifying information.

The database is populated with such things as:

Who ordered a particular test;

When was the particular test ordered;

When was the scheduling for the particular test done;

Who scheduled the particular test;

When was the particular test scheduled to be conducted;

When was the particular test actually conducted;

What was the expected date of test result;

When did the test result actually become available;

When did the doctor read the test results;

When did doctor convey the test results to the patient; and

When did the Final disposition occur and what was it.

Care providers can access the patients test history via the software and the database, and thereby determine the tests that have been conducted as well as the results and the interpretations given those results. In this manner redundant tests can be avoided care givers can be better informed, insurers will not undergo the expenses associated with redundant tests being performed. In addition, the software and the database can cooperate to sort test information stored in the database so that, for example:

A Doctor can track all of the tests he ordered for all his patients;

A Doctor seeing a particular patient can track all of the tests performed on that patient;

The tests information can be sorted so that only the tests ordered by a particular doctor are displayed, or all of the tests ordered by all of that patients doctors are displayed;

Care providers such as, but not limited to an MRI Nurse can check on all of the pending MRI's on a particular patient, or on all of the MRIs ordered by a particular doctor, or on all of the MRI's for the whole practice group of, for example, 100 doctors. This information can be sorted by the name of the patient, by doctor, or chronologically. However, the present invention is not limited in this regard, as, the information can be sorted by other criteria, such as, but not limited to, age; sex, ethnicity, hospital, etc.

In addition, the performance of caregivers can be monitored and evaluated by institutions, corporations, insurers, government agencies, supervisory personnel and the like. For example, insurers, hospitals, supervisory personnel, and the like can use the present invention to determine whether too much time has passed from when a test is ordered to when it is actually conducted to when the results are received, etc. In this manner, bottlenecks, overworked employees, and/or underperformers can be discovered and the problematic issues corrected. Insurers, corporations, and government agencies can use the information capable of being provided to include or exclude care givers as well as to reward efficient cost effective performance.

### DETAILED DESCRIPTION OF THE PREFERRED EMBODIMENTS

In a computer implemented method, medical tests and, as will be explained in detail below, information relevant to the medical tests can be input into, and stored in, a database. Software operable with the database can associate the test information with the patient, the health care provider ordering the test, the entity conducting the test, insurance companies, the type of test, particular ailments, and the like. The information can be retrieved by authorized entities for viewing and sorting. The database can be accessed from remote locations via various different means. For example, the database can be resident on a server that is part of an intranet accessible from remotely located terminals. The terminals can be wireless or hardwired. In addition, access may be gained via the internet over a virtual private network (VPN) or the like. As used herein, the word terminal should be broadly construed to include desktop computers, laptop computers, personal digital assistants, cellular telephones, tablets and the like.

The method can also be web based, with the test information being accessible via a website. A user can access the site and in order to view the test information, may be required to enter security protocols, such as, but not limited to, biometric information (fingerprint, palm print, or retinal scan), passwords, usernames, or combinations thereof.

The test information will be stored in electronic filing cabinets accessible via a user interface driven by software operable with the database and the terminals. Where a web-based system is employed, the software can also be operable with the website. Depending on such things as the particular health care provider, the particular test, and the like, will determine what filing cabinet information is stored in. The information stored in the database can include, but is not limited to:

Who ordered a particular test;

When was the particular test ordered;

When was the scheduling for the particular test done;

Who scheduled the particular test;

When was the particular test scheduled to be conducted;

When was the particular test actually conducted;

What was the expected date of test result;

When did the test result actually become available;

When did the doctor read the test results;

When did doctor convey the test results to the patient; and

When did the Final disposition occur and what was it.

Care providers can access the patients test history via the software and the database, and thereby determine the tests that have been conducted as well as the results and the interpretations given those results. In this manner redundant tests can be avoided care givers can be better informed, insurers will not undergo the expenses associated with redundant tests being performed. In addition, the software and the database can cooperate to sort test information stored in the database so that, for example:

A Doctor can track all of the tests he ordered for all his patients;

A Doctor seeing a particular patient can track all of the tests performed on that patient;

The tests information can be sorted so that only the tests ordered by a particular doctor are displayed, or all of the tests ordered by all of that patients doctors are displayed;

Care providers such as, but not limited to an MRI Nurse can check on all of the pending MRI's on a particular patient, or on all of the MRIs ordered by a particular doctor, or on all of the MRI's for the whole practice group of, for example, 100 doctors. This information can be sorted by the name of the patient, by doctor, or chronologically. However, the present invention is not limited in this regard, as, the information can be sorted by other criteria, such as, but not limited to, age; sex, ethnicity, hospital, etc.

In addition, the performance of caregivers can be monitored and evaluated by institutions, corporations, insurers, government agencies, supervisory personnel and the like. For example, insurers, hospitals, supervisory personnel, and the like can use the present invention to determine whether too much time has passed from when a test is ordered to when it is actually conducted to when the results are received. In this manner unusual gaps in time between events, lack of patient follow-up, and the like can be tracked and monitored. Conversely, superior performance by a health care provider can also be determined by reviewing the above-described criteria and the time within which the criteria were addressed. This will allow insurance companies, for example, to make pay-for -performance determinations.

The software is operable allow for health care providers to view the test information in the database, however, they will not, without proper authorizations, be able to change the information. The software can be operable to allow authorized health care providers to annotate certain information and to store these annotations in the database. These annotations can be viewable by the particular health care provider, or they may be made available to others accessing the information.

What is claimed is:

1. A method for tracking medical test information comprising:
establishing a content database cooperable with software, said content database being populable with identifying information relevant to particular patients and care providers;
receiving information relevant to tests performed or to be performed on one or more of said patients;
said software being operable with said content database to associate said information relevant to said tests with at least one of said patients and to store said information in said content database;
said information stored in said database and being retrievable therefrom, including:
Who ordered a particular test;
When was the particular test ordered;
When was the scheduling for the particular test done;
Who scheduled the particular test;
When was the particular test scheduled to be conducted;
When was the particular test actually conducted;
What was the expected date of test result;
When did the test result actually become available;
When did the doctor read the test results;
When did doctor convey the test results to the patient; and
When did the Final disposition occur and what was it;
said information being retrievable from said content database for viewing on a display; and
said software being operable to sort at least a portion of said information upon request by a user.

2. A method as defined by claim 1 including the further steps of:
requiring security protocol information to be received prior to allowing access to said information stored in said database.

3. A method as defined by claim 1 further comprising:
establishing a website;
said software being operable with said website to allow a user to access information stored in said database via said website.

4. A method as defined by claim 3 including the further steps of:
requiring security protocol information to be received prior to allowing access to said information stored in said database.

5. A method as defined by claim 1 wherein said software is operable to generate reports in accordance with said information sorted from said database.

6. A method as defined by claim 1 wherein said software, and thereby at least a portion of said database, is accessible by one or more of a PDA, a laptop, a tablet, and a cellular telephone.

7. A method as defined by claim 1 comprising the further steps of:
receiving and storing annotations relevant to at least one of a particular test and a particular patient; and
said software being operable to prevent a user from altering test information.
